(19) United States
(12) Patent Application Publication
(10) Pub. No.: US 2008/0135541 A1
(43) Pub. Date: Jun. 12, 2008

(54) HEATING APPARATUS FOR APPLIANCES

(75) Inventor: ZHENG PENG, Ypsilanti, MI (US)

Correspondence Address: ZHAOXIA XU, 4694 SYCAMORE DR., YPSILANTI, MI, 48197, US

(73) Assignee: ZHENG PENG, YPSILANTI, MI (US)

(21) Appl. No.: 11/608,822

(22) Filed: Dec. 9, 2006

(51) Int. Cl. F27D 11/06

(52) U.S. Cl. 219/438

(57) ABSTRACT

A heating assembly (100) for appliances. Assembly (100) comprises a tray shaped base support (102) for holding parts together, a heater plate (104) installed above support (102) for thermal diffusion and for supporting cooking utensils, a sidewall (106) extended from the peripheral outer rim of plate (104) downward to a predetermined distance and sealingly installed onto support (102), a tubular electrical heating element (116) fixedly installed under plate (104) for providing heating power, and a insulation material filled into the space enclosed by plate (104), wall (106), and support (102) for thermal insulation.

### TECHNICAL FIELD AND INDUSTRIAL APPLICABILITY OF THE INVENTION

This invention generally relates to heaters. More specifically, this invention relates to heaters for appliances.

### BACKGROUND OF THE INVENTION

Traditional heating assemblies for appliances include a heater plate installed onto a base support by means of screws screwed into one or multiple lugs extended downward from the bottom of the heater plate for thermal diffusion and for supporting cooking utensils and a tubular electrical heating element adapted to be fixed under the heater plate for supplying heating power. The base support can be a flat plate or surface, or a tray shaped shallow plate, or, most commonly, is a pan shaped plate having a flat bottom and a sidewall extending upward to a predetermined height.

The problem associated with the prior art heating assemblies is that food debris or cooking liquids may accidentally fall or flow underneath the heater plate, resulting in immediate sanitary issues and potential safety issues. Based on NSF standards for cooking appliances, the space in between the heater plate and the base support is classified as “splash zone”, which should be reasonably easy for cleaning. Obviously prior art heating assemblies do not meet these standards. Even for household use, consumers desire their cooking appliances easy to clean after use.

Therefore, it remains desirable to provide a heating assembly for appliances that satisfies NSF standards for cooking appliances, such that it can be used for commercial applications. It remains desirable to provide a heating assembly for household appliances that is convenient for cleaning.

### BRIEF SUMMARY OF THE INVENTION

Accordingly, the present invention is a heating assembly for appliances. This heating assembly comprises a base support for holding parts together, a heater plate for heat diffusion and for supporting cooking utensils, a sidewall extending from the peripheral outer rim of the heater plate downward to a predetermined distance and sealingly installed on the base support, such that no food debris or cooking liquids would drop or flow under the heater plate, a tubular electrical heating element fixedly installed on the back of the heater plate, and a heat insulation material inserted into the space enclosed by the heater plate, the sidewall, and the base support for thermal insulation.

Accordingly, the followings are some of the objects, features, and advantages of the present invention.

It is an object of the present invention to provide a heating assembly for appliances that satisfies NSF standards for cooking appliances.

It is another object of the present invention to provide a heating assembly for appliances that is highly efficient in heating and that is convenient for cleaning.

It is a feature of the present invention that this heating assembly includes a heater plate and a sidewall extending from the peripheral outer rim of the heating plate downward to a predetermined distance and sealingly installed on the base support, such that the space underneath the heater plate is contained.

It is another feature of the present invention that the space between the base support and the heater plate is filled with a thermal insulation material for preventing heat transfer to the base support.

It is an advantage of the present invention that the heating assembly meets NSF standards for cooking appliances, is highly efficient in heating, and is convenient for cleaning.

Further more features and advantages of the present invention will be readily appreciated, as the same becomes better understood after reading the subsequent description when considered in connection with the accompanying non-limiting drawings.

### BRIEF DESCRIPTION OF THE DRAWINGS

FIG. 1 illustrates a cross-sectional view of an embodiment of the present invention, a heating assembly 100 for appliances.

FIG. 2 illustrates a cross-sectional view of an alternative design of heating assembly 100 for appliances

### DETAILED DESCRIPTION OF THE INVENTION

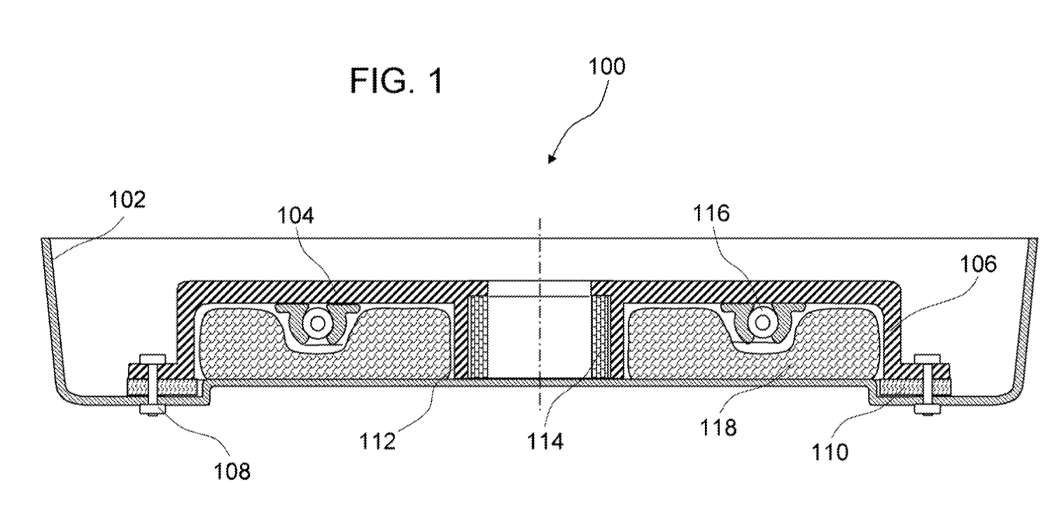

Reference is made to FIG. 1, which illustrates a cross-sectional view of an embodiment of the present invention, a heating assembly 100 for appliances.

A base support 102, a tray shaped plate having an open top and a flat bottom, is provided for holding parts together. Support 102 can alternatively be a flat plate or a deep pan shaped container, as known to those skilled in the art and suggested by this invention disclosure.

A heater plate 104, having a disc-shape configuration and a predetermined thickness, is provided for thermal diffusion and for supporting cooking utensils (not shown). Plate 104 is preferably made of a metal material of high thermal conductivity. A central aperture on plate 104 is provided as a space to install such parts as a temperature-sensing device for a rice cooker or a driving shaft for a self-stirring cooking appliance, etc.

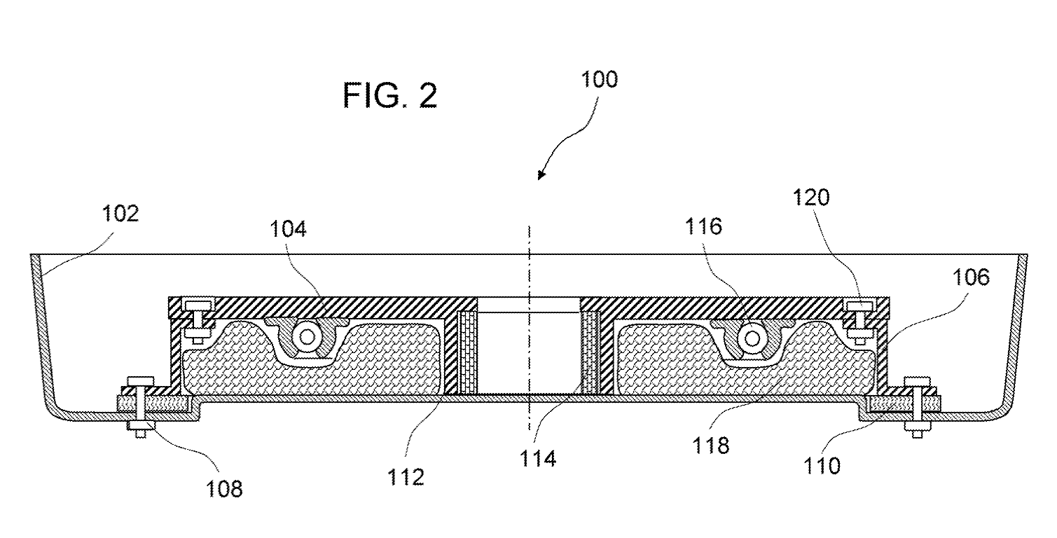

A sidewall 106 extends from the peripheral outer rim of heater plate 104 downward to a predetermined distance and is sealingly installed on the bottom of base support 102. Sidewall 106 is provided for enclosing the space underneath heater plate 104. Sidewall 106 can be an integral part of plate 104, as shown in FIG. 1, or a separate part engaged with plate 104, as will be more specifically discussed later and shown in FIG. 2. The lower end of sidewall 106 is sealingly engaged with the bottom of base support 102 through a plurality of bolts 108.

A ring shaped thermal insulation member 110 is installed in between the lower end of sidewall 106 and the bottom of base support 102 for preventing heat transfer from heater plate 104 to base support 102 through sidewall 106, thereby reducing heat loss and avoiding overheating of base support 102.

An inner cylindrical wall 112 extends from the central aperture opened on heater plate 104 downward to a predetermined distance and is engaged with the bottom of base support 102. Wall 112 is provided for enclosing the space underneath heater plate 104 from the inner side.

A thermal insulation hollow cylinder 114 is inserted inside inner cylindrical wall 112 for preventing the heating up of the inner space inside wall 112, thereby reducing the heating load of the parts installed therewithin (not shown).

A tubular electrical heating element 116 is fixedly installed under heater plate 104 for providing heating power to heater plate 104.

A thermal insulation material 118 is inserted into the space enclosed by heater plate 104, sidewall 106, inner cylindrical wall 112, and the bottom of base support 102 to reduce heat transfer from heater plate 104 to base support 102, whereby parts underneath base support 102 (not shown) are not overheated.

FIG. 2 illustrates an alternative design of heating assembly 100 for appliances. In this alternative design, sidewall 106 is depicted as a separate part. The upper end of sidewall 106 is fixedly engaged with heater plate 104 through a plurality of bolts 120. The top heads of bolts 120 sink under the top surface of heater plate 104, such that the top surface of heater plate 104 would maintain good contact with cooking utensils for efficient heat transfer. The lower end of sidewall 106 is sealingly installed on the bottom of base support 102.

Accordingly, readers will see that this heating assembly of the present invention includes a sidewall for excluding food debris or cooking liquids from dropping or flowing into the space underneath the heater plate, such that it would meet NSF standards for cooking appliances in sanitation. The heating assembly is also highly efficient in heating because of the thermal insulation underneath the heater plate.

The present invention has been described in an illustrative manner. It is to be understood that the terminology, which has been used, is intended to be in the nature of words of description rather than of limitation.

Although this invention has been described in its preferred forms and structures with a certain degree of particularity, these should not be construed as limiting the scope of the invention but as merely providing illustrations of some of the presently preferred embodiments of this invention.

Thus it is understood that the present disclosure of the preferred forms can be changed in the details of construction and in the combination and arrangement of parts without departing from the spirit and the scope of the invention as hereinafter claimed.

What is claimed is:

1. A heating apparatus for appliances, said heating apparatus comprising:
A base support for holding parts;
a heater plate installed above said base support for thermal diffusion and for supporting cooking utensils;
a sidewall extended from the peripheral outer rim of said heater plate downward to a predetermined distance;
wherein the lower end of said sidewall is sealingly installed on said base support, such that the space underneath said heater plate is contained;
whereby food debris or cooking liquids are prevented from dropping or flowing into the space under said heater plate; and
a tubular heating element fixedly installed under said heater plate for providing heating power.

2. A heating apparatus for appliances as defined in claim 1, wherein said heating apparatus further includes a thermal insulation spacer installed in between the lower end of said sidewall and said base support for preventing heat transfer from said heater plate to said base support through said sidewall.

3. A heating apparatus for appliances as defined in claim 1, wherein said heating apparatus further includes a inner cylindrical wall extended from a central aperture opened on said heater plate, wherein said inner cylindrical wall extends downward to a predetermined distance, and wherein the lower end of said inner cylindrical wall is engaged with said base support.

4. A heating apparatus for appliances as defined in claim 1, wherein said base support is a tray shaped plate having an open top and wherein the lower end of said sidewall is sealingly installed on the bottom of said tray shaped plate.

5. A heating apparatus for appliances as defined in claim 3, wherein said heating apparatus further includes a thermal insulation hollow cylinder installed in the inner space enclosed by said inner cylindrical wall for thermal insulation.

6. A heating apparatus for appliances as defined in claim 3, wherein a thermal insulation material is inserted inside the space enclosed by said heater plate, said sidewall, said inner cylindrical wall, and said base support for thermal insulation.

7. A heating apparatus for appliances, said heating apparatus comprising:
A base support for holding parts;
a heater plate, having a central aperture, installed above said base support for thermal diffusion and for supporting cooking utensils;
a sidewall extended from the peripheral outer rim of said heater plate downward to a predetermined distance;
wherein the lower end of said sidewall is sealingly installed on said base support, such that the space underneath said heater plate is contained;
whereby food debris or cooking liquids are prevented from dropping or flowing into the space under said heater plate;
an inner cylindrical wall extended from the central aperture of said heater plate downward to a predetermined distance;
wherein the lower end of said inner cylindrical wall is engaged with said base support; and
a tubular heating element fixedly installed under said heater plate for providing heating power.

8. A heating apparatus for appliances as defined in claim 7, wherein said heating apparatus further includes a thermal insulation spacer installed in between the lower end of said sidewall and said base support for preventing heat transfer from said heater plate to said base support through said sidewall.

9. A heating apparatus for appliances as defined in claim 7, wherein said heating apparatus further includes a thermal insulation hollow cylinder installed in the inner space enclosed by said inner cylindrical wall for thermal insulation.

10. A heating apparatus for appliances as defined in claim 7, wherein a thermal insulation material is inserted inside the space enclosed by said heater plate, said sidewall, said inner cylindrical wall, and said base support for thermal insulation.

11. A heating apparatus for appliances as defined in claim 7, wherein said base support is a tray shaped plate having an open top and wherein the lower end of said sidewall is sealingly installed on the bottom of said tray shaped plate.

12. A heating apparatus for appliances, said heating apparatus comprising:
A base support for holding parts;
a heater plate having a central aperture installed above said base support for thermal diffusion and for supporting cooking utensils;
a sidewall having two ends;
wherein the upper end of said sidewall is engaged with said heater plate substantially close to the peripheral outer rim of said heater plate;
wherein said sidewall extends downward to a predetermined distance;
wherein the lower end of said sidewall is sealingly engaged with said base support, such that the space underneath said heater plate is contained;
whereby food debris or cooking liquids are prevented from dropping or flowing into the space underneath said heater plate;
an inner cylindrical wall having two ends;
wherein the upper end of said inner cylindrical wall is engaged with said heater plate substantially close to the central aperture of said heater plate;
wherein said inner cylindrical wall extends downward to a predetermined distance;
wherein the lower end of said inner cylindrical wall is engaged with said base support; and
a tubular heating element fixedly installed under said heater plate for providing heating power.

13. A heating apparatus for appliances as defined in claim 12, wherein said base support is a tray shaped plate having an open top and wherein the lower end of said sidewall is sealingly engaged with the bottom of said tray shaped plate.

14. A heating apparatus for appliances as defined in claim 12, wherein said heating apparatus further includes a thermal insulation spacer installed in between the lower end of said sidewall and said base support for preventing heat transfer from said heater plate to said base support through said sidewall.

15. A heating apparatus for appliances as defined in claim 12, wherein said heating apparatus further includes a thermal insulation hollow cylinder installed in the inner space enclosed by said inner cylindrical wall for thermal insulation.

16. A heating apparatus for appliances as defined in claim 12, wherein a thermal insulation material is inserted inside the space enclosed by said heater plate, said sidewall, said inner cylindrical wall, and said base support for thermal insulation.
